(19) United States
(12) Patent Application Publication
(10) Pub. No.: US 2026/0242032 A1
(43) Pub. Date: Aug. 20, 2026

(54) BIKE TRAILER FOLDING STRUCTURE

(71) Applicant: Cheh-Kang Liu, Taipei (TW)

(72) Inventor: Cheh-Kang Liu, Taipei (TW)

(21) Appl. No.: 19/055,657

(22) Filed: Feb. 18, 2025

(51) Int. Cl. B62K 27/02; B62K 27/00; B62K 27/10

(52) U.S. Cl. CPC B62K 27/02; B62K 27/003; B62K 27/10

(57) ABSTRACT

A bike trailer folding structure includes a bottom frame, a front frame the with lower ends of left and right side tubes thereof connected to front ends of left and right sides of the bottom frame respectively, and a rear frame with a buckle member provided on an upper tube thereof and lower ends of left and right rear branch tubes thereof respectively connected with rear ends of left and right sides of the bottom frame through a respective first pivot. After released the buckle member, turn the rear frame toward the bottom frame and then turn the front frame toward the bottom frame to collapse the bike trailer folding structure. When unfolding the bike trailer folding structure, pivot the front and rear frames upwards and use the buckle member and the reinforcing tube of the front frame to snap into place.

### BACKGROUND OF THE INVENTION

### 1. Field of the Invention

The present invention refers to a bike trailer folding structure, which relates to a related technical field of a bike trailer folding structure that can be simply and conveniently folded or unfolded and whose front and rear frames do not require any foldable joints but only one buckle member is needed to fix or release the entire frame structure.

### 2. Description of the Related Art

According to the conventional trailer structure that folds in the front and rear directions, it is usually necessary to set a foldable joint on the front frame or rear frame. This not only increases the cost of the components, but also wastes manpower and time for assembly. In addition, the operation method for users to fold or unfold the trailer is relatively troublesome and needs to be improved.

In addition, the previous U.S. Pat. No. 7,341,265 “Frame Structure for Foldable Baby Trailer” by the same inventor as this application discloses the technology related to folding in the left and right directions. After the two sides of the transverse top bar are separated from the top frame bars on the left and right sides, the first frames of the top frame bars on the left and right sides can be folded toward the second frames respectively, and finally folded toward the bottom frame.

### SUMMARY OF THE INVENTION

In view of the above, the inventor has designed this bike trailer folding structure after continuous research and improvement.

Therefore, the main object of the present invention is to provide a bike trailer folding structure, which allows users to fold or unfold the trailer easily and conveniently.

The second object of the present invention is to provide a bicycle trailer folding structure, in which the front and rear frames do not need to be provided with any foldable joints but only one buckle member is needed to fix or release the entire frame structure, which not only reduces the cost but also relatively saves the manpower and working hours for assembling the front and rear frames.

### BRIEF DESCRIPTION OF THE DRAWING

FIG. 1 is a three-dimensional diagram of the unfolded state of the preferred embodiment of the present invention.

FIG. 2 is a three-dimensional diagram of the present invention in which the rear frame is in a folded state.

FIG. 3 is a three-dimensional diagram of the folded and collapsed state of the preferred embodiment of the present invention.

FIG. 4 is a three-dimensional diagram of the exploded state of the preferred embodiment of the present invention.

FIG. 5 is an enlarged schematic diagram of a partial assembly of the left side tube and the connecting member of the front frame in the preferred embodiment of the present invention.

FIG. 6 is an enlarged schematic diagram of a partial assembly of the left side tube of the front frame and another connecting member according to the preferred embodiment of the present invention.

FIG. 7 is an enlarged schematic diagram of a partial assembly of the left side tube of the front frame and another connecting member according to the preferred embodiment of the present invention.

FIG. 8 is an enlarged schematic diagram of a partial assembly of the right side tube and the connecting member of the front frame according to the preferred embodiment of the present invention.

FIG. 9 is an enlarged schematic diagram of a partial assembly of the right side tube of the front frame and another connecting member according to the preferred embodiment of the present invention.

FIG. 10 is an enlarged schematic diagram of a partial assembly of the right side tube of the front frame and another connecting member according to the preferred embodiment of the present invention.

FIG. 11 is a three-dimensional diagram of the unfolded state after adding a handle to the preferred embodiment of the present invention.

FIG. 12 is a three-dimensional diagram of the folded and collapsed state of the present invention after adding a handle.

### DETAILED DESCRIPTION OF THE INVENTION

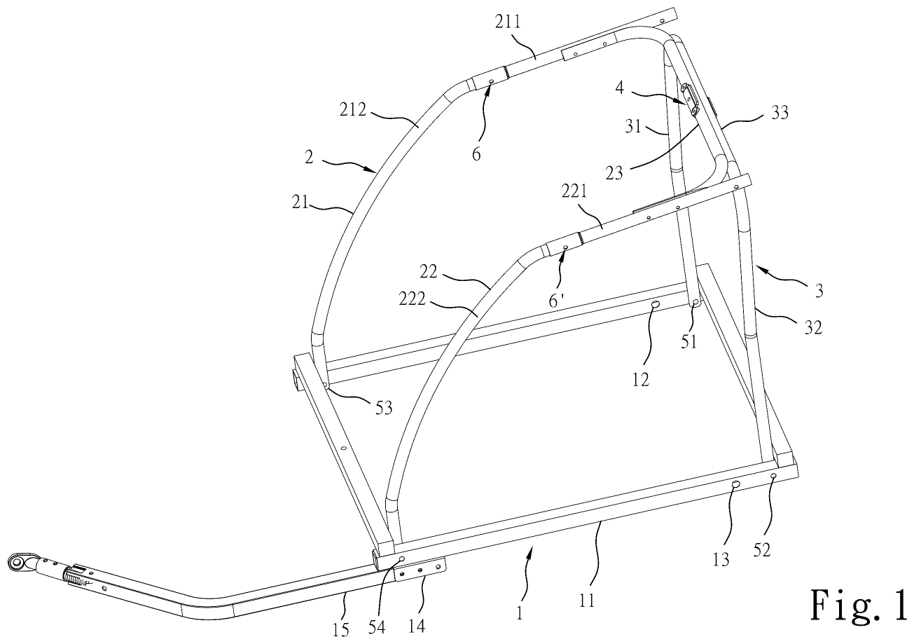

As shown in FIG. 1 to FIG. 3, the present invention provides an improved folding structure of a bike trailer, wherein the trailer folding structure 1 comprises a bottom frame 11, a front frame 2, and a rear frame 3.

The bottom frame 11 is provided with a left wheel mounting portion 12 and a right wheel mounting portion 13 at the rear of the left and right sides, respectively, for mounting a left wheel (not shown) and a right wheel (not shown) respectively. In this embodiment, the left wheel mounting portion 12 and the right wheel mounting portion 13 are respectively a left mounting hole and a right mounting hole, but this is not limited thereto. The left wheel mounting portion 12 and the right wheel mounting portion 13 may also be a left wheel frame (not shown) and a right wheel frame (not shown), respectively, and a bicycle connecting seat 14 is provided at the front of one of the left and right sides of the bottom frame 11 to which a link 15 can be mounted for connecting with a bicycle (not shown).

The rear frame 3 comprises an upper tube 33 and a left rear branch tube 31 and a right rear branch tube 32. The upper ends of the left rear branch tube 31 and the right rear branch tube 32 are connected to the left and right ends of the upper tube 33 respectively.

The characteristics of the trailer folding structure 1 are as follows:

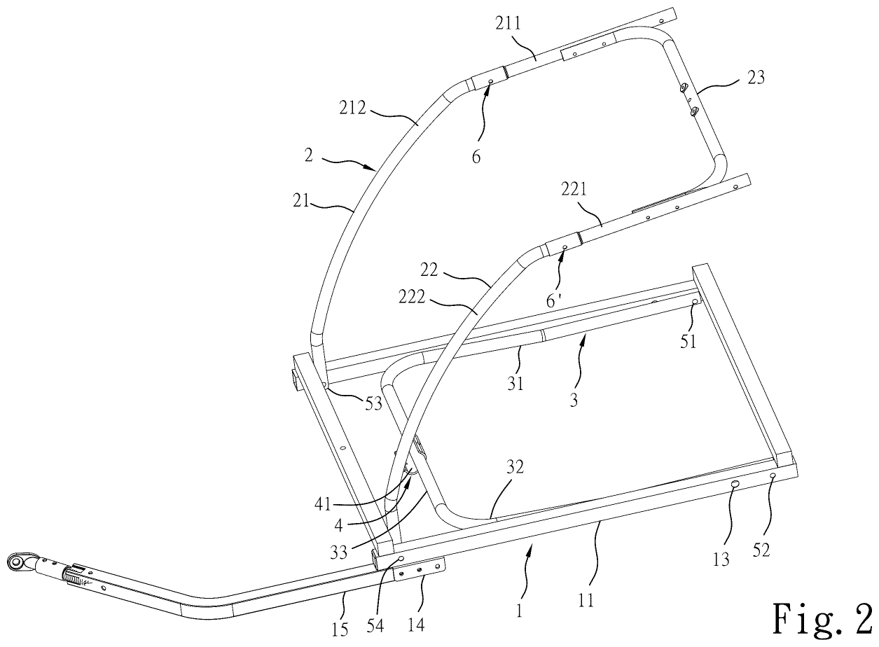

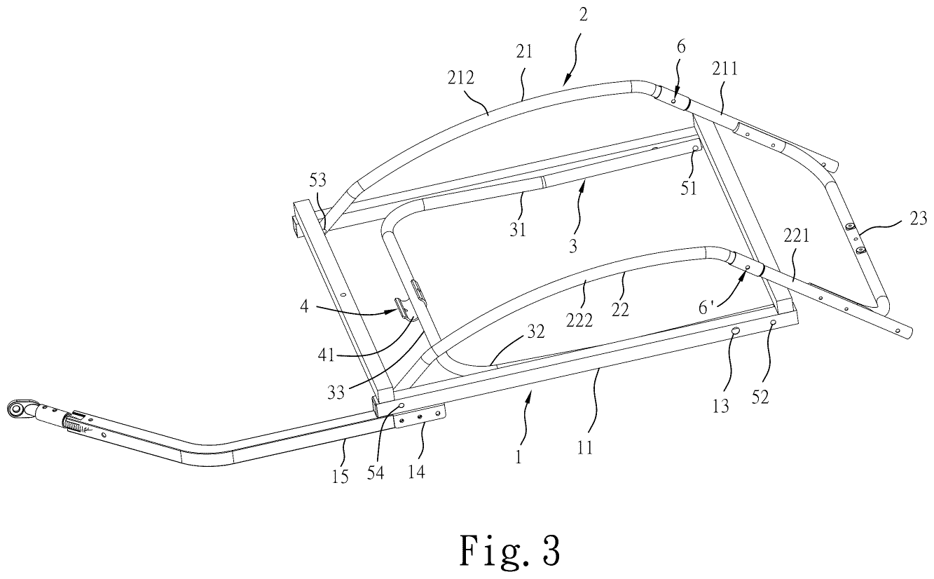

The upper tube 33 of the rear frame 3 is provided with a buckle member 4 (refer to FIG. 1 and FIG. 3), and the lower ends of the left rear branch tube 31 and the right rear branch tube 32 of the rear frame 3 are respectively pivotally connected to the rear ends of the left and right sides of the bottom frame 11 through a first pivot 51 and a second pivot 52. The front frame 2 comprises a left side tube 21, a right side tube 22, and a reinforcing tube 23 connecting the upper part of the left side tube 21 and the upper part of the right side tube 22. The lower end of the left side tube 21 and the lower end of the right side tube 22 are respectively connected to the front ends of the left and right sides of the bottom frame 11. The reinforcing tube 23 is used to be locked in place (see FIG. 1) or released (see FIG. 2 to FIG. 3) by the buckle member 4 provided on the rear frame 3.

Thus, only one buckle member is needed to fix or release the entire frame structure. When folding and collapsing, the user only needs to release the buckle member 4 from the reinforcing tube 23 of the front frame 2, and then pivot the rear frame 3 to fold it toward the bottom frame 11 (see FIG. 2), and then pivot the front frame 2 toward the bottom frame 11 to complete the folding and collapsing in a simple, fast and convenient manner (see FIG. 3). On the contrary, when it is desired to unfold, the front frame 2 and the rear frame 3 are pivoted upwards, and the buckle member 4 and the reinforcing tube 23 of the front frame 2 are snapped in place, so that the unfolded state can be completed simply, conveniently and quickly (refer to FIG. 1). Furthermore, since the front frame 2 and the rear frame 3 do not need to be provided with any foldable joints but only one buckle member is needed to fix or release the entire frame structure, not only the cost is reduced, but also the manpower and working hours for assembling the front frame 2 and the rear frame 3 are relatively saved.

Furthermore, in this embodiment, the buckle member 4 provided in the rear frame 3 is made of plastic material and has a buckle groove 41 (refer to FIGS. 2 and 3) to correspond to the predetermined position of the reinforcing tube 23 of the front frame 2 for buckling and positioning (refer to FIG. 1) or releasing and disengaging (refer to FIGS. 2 and 3). However, the present invention is not limited by this, and any equivalent application should be included in the scope of this patent.

In addition, in this embodiment, the front frame 2 can be disassembled to save material, but this invention is not limited to this.

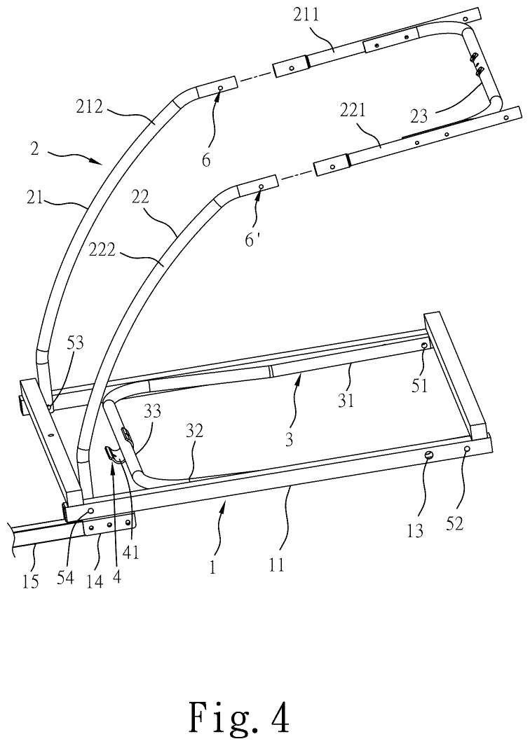

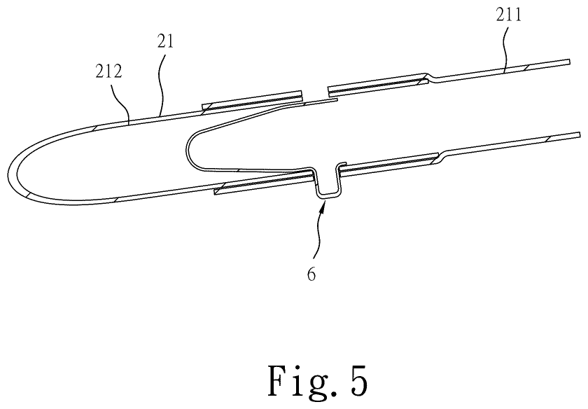

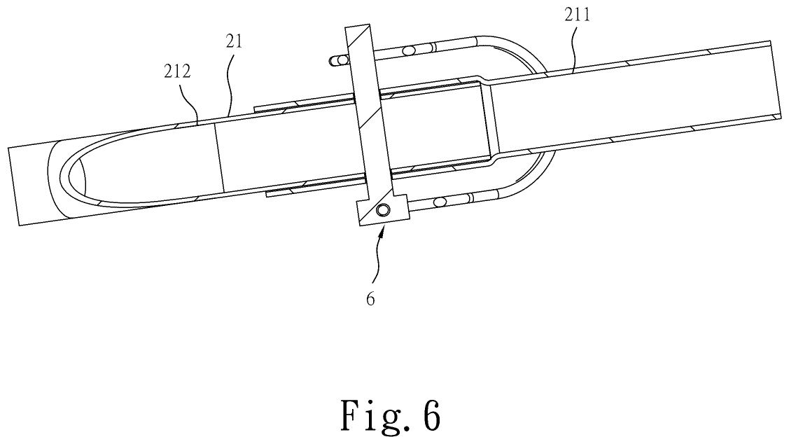

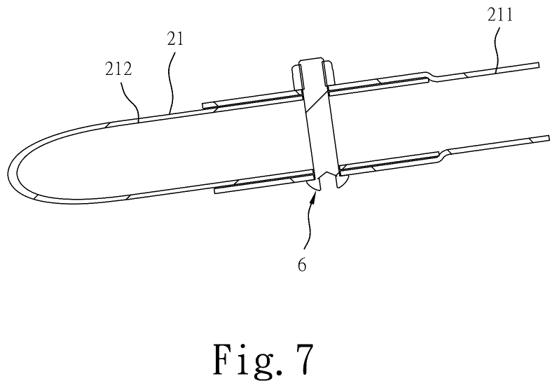

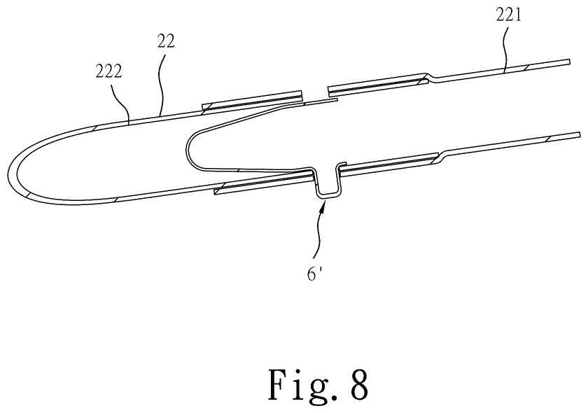

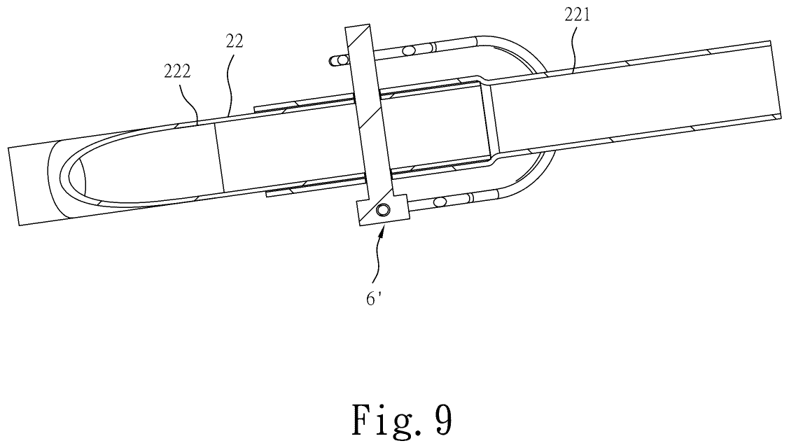

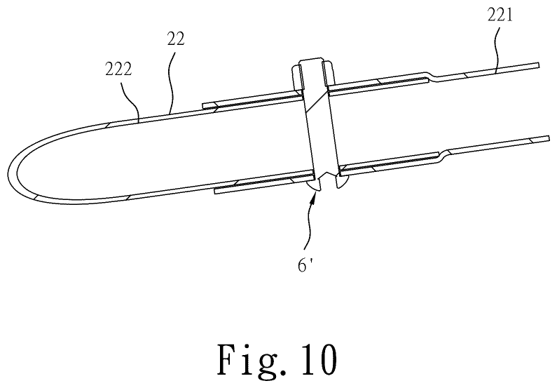

Please refer to FIG. 4, the left side tube 21 of the front frame 2 comprises a first left front support tube 211 and a second left front support tube 212. The first left front support tube 211 and the second left front support tube 212 are mutually sleeved and connected and fixed by a detachable first connecting member 6 such as a V-shaped spring sheet (see FIG. 5) or a latch (see FIG. 6) or a screw and a nut (see FIG. 7). The upper part of the first left front support tube 211 is connected to the left side of the reinforcing tube 23. The lower end of the second left front support tube 212 is connected to the front end of the left side of the bottom frame 11 through a third pivot 53. The right side tube 22 of the front frame 2 comprises a first right front support tube 221 and a second right front support tube 222. The first right front support tube 221 and the second right front support tube 222 are mutually sleeved and connected and fixed by a detachable second connecting member 6′ such as a V-shaped spring sheet (refer to FIG. 8) or a latch (refer to FIG. 9) or a screw and a nut (refer to FIG. 10). The upper end of the first right front support tube 221 is connected to the right side of the reinforcing tube 23, and the lower end of the second right front support tube 222 is pivoted to the front end of the right side of the bottom frame 1 through a fourth pivot 54.

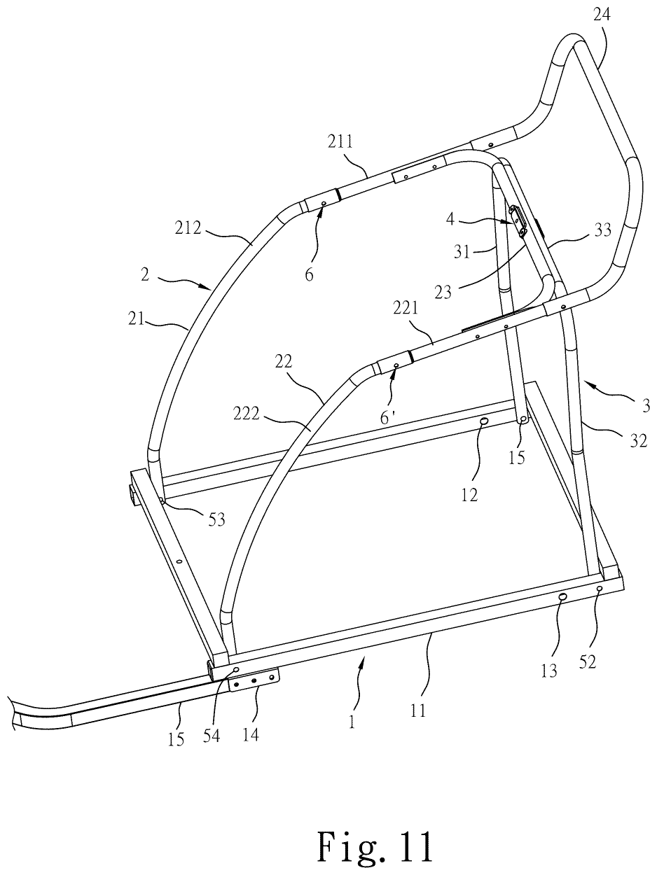

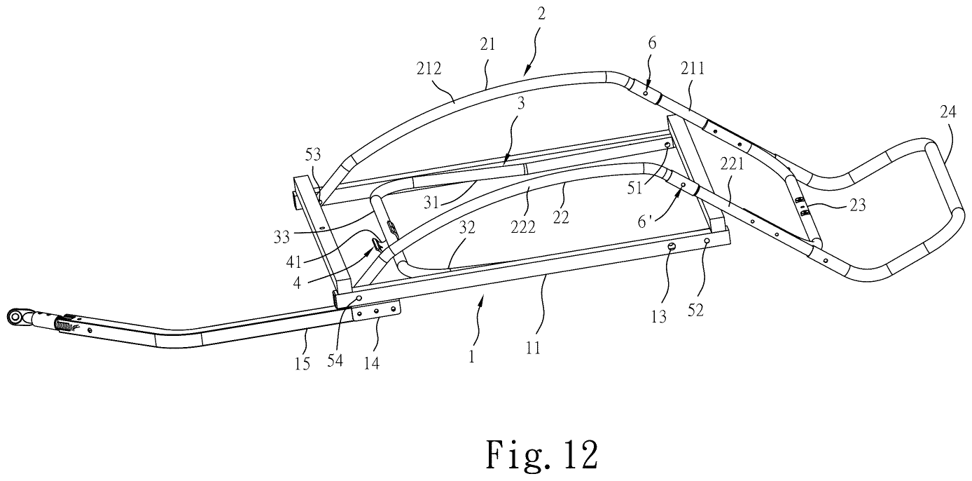

In addition, the front frame 2 of this embodiment may be further provided with a handle 24 (see also FIG. 11). Although the handle 24 is added, the user can still operate it simply and conveniently. When folding and collapsing, the user only needs to release the buckle member 4 from the reinforcing tube 23 of the front frame 2, and then pivot the rear frame 3 to fold it toward the bottom frame 1, and then pivot the front frame 2 toward the bottom frame 1 to complete the folding and collapsing process simply, quickly and conveniently (see FIG. 12). On the contrary, when it is desired to unfold, the front frame 2 and the rear frame 3 are pivoted upward and the buckle member 4 and the reinforcing tube 23 of the front frame 2 are buckled to position them, so that the unfolded state can be completed simply, conveniently and quickly (refer to FIG. 11).

In summary, the creation of this case can be summarized as having the following enhancement effects:
1. Users can fold or unfold the bike trailer easily and conveniently.
2. The front frame 2 and the rear frame 3 do not need to be equipped with any foldable joints but only one buckle member is needed to fix or release the entire frame structure, which not only reduces the cost, but also saves the manpower and working hours for assembling the front frame 2 and the rear frame 3.
3. You can choose to use a detachable front frame 2 to save material space.

What is claimed is:

1. A bike trailer folding structure, comprising:
a bottom frame comprising a left wheel mounting portion and a right wheel mounting portion respectively located at a rear of left and right sides thereof, for mounting a left wheel and a right wheel respectively, a bicycle connecting seat provided at a front of one of the left and right sides of said bottom frame to which a link is to be mounted for connecting with a bicycle;
a front frame; and
a rear frame comprising an upper tube, a left rear branch tube and a right rear branch tube, said left rear branch tube and said right rear branch tube having a respective upper end thereof respectively connected to left and right ends of said upper tube;
wherein:
said upper tube of said rear frame is provided with a buckle member, and said left rear branch tube and said right rear branch tube of said rear frame have a respective lower end pivotally connected to respective rear ends of the left and right sides of said bottom frame through a first pivot and a second pivot respectively;
said front frame comprises a left side tube, a right side tube and a reinforcing tube connecting an upper end of said left side tube and an upper end of said right side tube, said left side tube and said right side tube having a respective opposing lower end respectively connected to respective front ends of the left and right sides of said bottom frame, said reinforcing tube being used to be locked in place or released by said buckle member provided on said rear frame;
when folding and collapsing the trailer folding structure, the user only needs to release said buckle member from said reinforcing tube of said front frame, and then pivot said rear frame to fold said rear frame toward said bottom frame, and then pivot said front frame toward said bottom frame to complete the folding and collapsing in a simple, fast and convenient manner; on the contrary, when unfolding the trailer folding structure, pivot said front frame and said rear frame upwards to snap said buckle member and said reinforcing tube of said front frame in place, so that the unfolded state is completed simply, conveniently and quickly.

2. The bike trailer folding structure as claimed in claim 1, wherein said buckle member provided in said rear frame is provided with a buckle groove to correspond to a predetermined part of said reinforcing tube of said front frame for buckling and positioning or releasing and disengaging.

3. The bike trailer folding structure as claimed in claim 1, wherein said left side tube of said front frame comprises a first left front support tube and a second left front support tube mutually sleeved and a first connecting member detachably fixing said first left front support tube and said second left front support tube, said first left front support tube having an upper end thereof connected to a left side of said reinforcing tube, said second left front support tube having a lower end thereof connected to the front of the left side of said bottom frame through a third pivot; said right side tube of said front frame comprises a first right front support tube and a second right front support tube mutually sleeved and a second connecting member detachably fixing said first right front support tube and said second right front support tube, said first right front support tube having an upper end thereof connected to an opposing right side of said reinforcing tube, said second right front support tube having a lower end thereof pivoted to the front of the right side of said bottom frame through a fourth pivot.

4. The bike trailer folding structure as claimed in claim 3, wherein said first connecting member is selectively a V-shaped spring or a latch or a screw and a nut; said second connecting member is selectively a V-shaped spring or a latch or a screw and a nut.
